(19) United States
(12) Patent Application Publication
(10) Pub. No.: US 2012/0156590 A1
(43) Pub. Date: Jun. 21, 2012

(54) DIRECT OXIDATION FUEL CELL WITH IMPROVED FUEL DISTRIBUTION

(76) Inventors: Chao-Yang WANG, State College, PA (US); Liang WANG, State College, PA (US); Yongjun LENG, State College, PA (US); Hiroaki Matsuda, Osaka (JP)

(21) Appl. No.: 12/973,149

(22) Filed: Dec. 20, 2010

(51) Int. Cl. H01M 8/04; H01M 8/22; H01M 8/00

(52) U.S. Cl. 429/514; 429/535

(57) ABSTRACT

A direct oxidation fuel cell (DOFC) having a liquid fuel and an anode electrode configured to generate power. The anode electrode includes a phase separation layer (PSL) positioned between a fuel channel plate and a GDL. The PSL can include at least one porous layer to improve fuel distribution and increase fuel cell performance.

### FIELD OF THE INVENTION

The present disclosure relates generally to fuel cells, fuel cell systems, and electrodes/electrode assemblies for the same. In particular, the present disclosure relates to electrodes with improved gas diffusion media, suitable for direct oxidation fuel cells (hereinafter “DOFC”), such as direct methanol fuel cells (hereinafter “DMFC”), and their components. More specifically, the present disclosure relates to anode electrodes configured to provide improved fuel delivery and fuel cell performance.

### BACKGROUND OF THE DISCLOSURE

A DOFC is an electrochemical device that generates electricity from electrochemical oxidation of a liquid fuel. DOFC's do not require a preliminary fuel processing stage; hence, they offer considerable weight and space advantages over indirect fuel cells, i.e., cells requiring preliminary fuel processing. Liquid fuels of interest for use in DOFC's include methanol, formic acid, dimethyl ether, etc., and their aqueous solutions. The oxidant may be substantially pure oxygen or a dilute stream of oxygen, such as that in air. Significant advantages of employing a DOFC in portable and mobile applications (e.g., notebook computers, mobile phones, personal data assistants, etc.) include easy storage/handling and high energy density of the liquid fuel.

One example of a DOFC system is a direct methanol fuel cell (DMFC). A DMFC generally employs a membrane-electrode assembly (hereinafter “MEA”) having an anode, a cathode, and a proton-conducting membrane electrolyte positioned therebetween. In the MEA, a catalyst layer is usually supported on the gas diffusion layer (GDL) that is made of either a woven carbon cloth or a non-woven carbon. The micro porous layers (MPL), is placed between the catalyst layer and GDL and is intended to provide wicking of liquid water into the GDL, minimize electric contact resistance with the adjacent catalyst layer, and furthermore prevent the catalyst layer from leaking into the GDL, thereby increasing the catalyst utilization and reducing the tendency of electrode flooding.

A typical example of a membrane electrolyte is one composed of a perfluorosulfonic acid-tetrafluorethylene copolymer, such as NAFION® (NAFION® is a registered trademark of E.I. Dupont de Nemours and Company). In a DOFC, an alcohol/water solution is directly supplied to the anode as the fuel and air is supplied to the cathode as the oxidant. At the anode, the alcohol, such as methanol reacts with water in the presence of a catalyst, typically a Pt or Ru metal-based catalyst, to produce carbon dioxide, H⁺ ions (protons), and electrons. The electrochemical reaction is shown as equation (1) below:

CH₃OH+H₂O→CO₂+6H⁺+6e⁻ (1)

During operation of the DOFC, the protons migrate to the cathode through the proton-conducting membrane electrolyte, which is non-conductive to electrons. The electrons travel to the cathode through an external circuit for delivery of electrical power to a load device. At the cathode, the protons, electrons, and oxygen molecules, typically derived from air, are combined to form water. The electrochemical reaction is given in equation (2) below:

3/2O₂+6H⁺+6e⁻→3H₂O (2)

Electrochemical reactions (1) and (2) form an overall cell reaction as shown in equation (3) below:

CH₃OH+ 3/2O₂→CO₂+2H₂O (3)

One drawback of a conventional DOFC is that the alcohol, such as methanol partly permeates the membrane electrolyte from the anode to the cathode, such permeated methanol being termed “crossover methanol”. The crossover methanol chemically and/or electrochemically reacts with oxygen at the cathode, causing a reduction in fuel utilization efficiency and cathode potential, with a corresponding reduction in power generation of the fuel cell. It is thus conventional for DOFC systems, to use excessively dilute (3-6% by vol.) alcohol solutions for the anode reaction in order to limit crossover and its detrimental consequences. However, the problem with such a DOFC system is that it requires a significant amount of water to be carried in a portable system, thus diminishing the system energy density.

The ability to use highly concentrated fuel is desirable for portable power sources, particularly since DOFC technology is currently competing with advanced batteries, such as those based upon lithium-ion technology. However, even if the fuel cartridge with highly concentrated fuel (e.g., pure or “neat” methanol) carries little to no water, the anodic reaction, i.e., equation (1), still requires one water molecule for each methanol molecule for complete electro-oxidation. Simultaneously, water is produced at the cathode via reduction of oxygen, i.e., equation (2). Therefore, in order to take full advantage of a fuel cell employing highly concentrated fuel, it is considered desirable to: (a) maintain a net water balance in the cell where the total water loss from the cell (mainly through the cathode) preferably does not exceed the net production of water (i.e., two water molecules per each methanol molecule consumed according to equation (3)), and (b) transport some of the produced water from the cathode to anode.

A plurality of approaches have been developed to meet the above-mentioned goals in order to directly use concentrated fuel. A first approach is an active water condensing and pumping system to recover cathode water vapor and return it to the anode (U.S. Pat. No. 5,599,638). While this method achieves the goal of carrying concentrated (and even neat) methanol in the fuel cartridge, it suffers from a significant increase in system volume and parasitic power loss due to the need for a bulky condenser and its cooling/pumping accessories.

Another approach is a passive water return technique in which hydraulic pressure at the cathode is generated by including a highly hydrophobic microporous layer (hereinafter “MPL”) in the cathode, and this pressure is utilized for driving water from the cathode to the anode through a thin membrane (Ren et al. and Pasaogullari & Wang, J. Electrochem. Soc., pp A399-A406, March 2004). While this passive approach is efficient and does not incur parasitic power loss, the amount of water returned, and hence the concentration of methanol fuel, depends strongly on the cell temperature and power density.

Presently, direct use of neat methanol is demonstrated at or below 40° C. and at low power density (less than 30 mW/cm²). Considerably less concentrated alcohol fuel, such as methanol is utilized in high power density (e.g., 60 mW/cm²) systems at elevated temperatures, such as 60° C. In addition, the requirement for thin membranes in this method sacrifices fuel efficiency and operating cell voltage, thus resulting in lower total energy efficiency.

In order to utilize highly concentrated fuel with DOFC systems, such as DMFC systems described above, it is preferable to reduce the oxidant stoichiometry ratio, i.e., flow of oxidant (air) to the cathode for reaction according to equation (2) above. In turn, operation of the cathode must be optimized so that liquid product(s), e.g., water, formed on or in the vicinity of the cathode can be removed therefrom without resulting in substantial flooding of the cathode.

Accordingly, there is a prevailing need for DOFC/DMFC systems that maintain a balance of water in the fuel cell and return a sufficient amount of water from the cathode to the anode when operated with highly concentrated fuel and low oxidant stoichiometry ratio, i.e., less than about 8. There is an additional need for DOFC/DMFC systems that operate with highly concentrated fuel, including neat methanol, and minimize the need for external water supplies or condensation of electrochemically produced water.

Therefore, it is desirable to reduce methanol crossover from the anode to the cathode. There are several methods to reduce methanol crossover: (1) develop alternative proton conducting membranes with low methanol permeability, (see, N. W. Deluca and Y. A. Elabd, Polymer electrolyte membranes for the direct methanol fuel cell: A review, Journal of Polymer Science: Part B: Polymer Physics, 44, pp. 2201-2225, 2006 and V. Neburchilov, J. Martin, H. J. Wang, J. J. Zhang, A Review of Polymer Electrolyte Membranes for Direct Methanol Fuel Cells, Journal of Power Sources, 169, pp. 221-238, 2007); (2) modify the existing membrane like NAFION® by making it a composite with inorganic and organic materials, or by executing the membrane surface modification, (see Delucca et al., and Neburchilov et al.); (3) control the mass transport in the anode through a porous carbon plate. (See M. A. Abdelkareem and N. Nakagawa, DMFC employing a porous plate for an efficient operation at high methanol concentrations, Journal of Power Sources, 162, pp. 114-123, 2006).

However, the above-mentioned methods have certain disadvantages. In Method (1), low proton conductivity of alternative polymer electrolyte membranes and low compatibility/adhesion with NAFION®-bonded electrodes limit the attainment of high power density. In Method (2), modification of NAFION® membrane may lead to the decrease of proton conductivity and stability. In Method (3), the addition of porous carbon plate increases the thickness of each unit cell and hence increases the stack volume; and it likely increases the manufacturing cost of a DMFC system.

Therefore, another approach of configuring DOFC/DMFC systems to include an anode diffusion medium, more commonly known as a gas diffusion layer (GDL), which facilitates a reduction of methanol crossover has been proposed in US Patent Application Publication Number. 20100-221625, the contents of which are herein incorporated by reference.

A complex two-phase flow in the anode channels occurs in DOFC/DMFC systems, in which liquid fuels such as methanol are the reactants and CO₂ gas is the product. This gas-liquid co-flow causes unstable operation, gas blockage and requires high fuel flow ratio (e.g. stoichiometry). The latter further deteriorates methanol crossover, reducing cell performance and fuel efficiency. In conventional DOFCs, a porous media with a high porosity such as carbon papers is used as a gas diffusion layer (GDL) in the anode side in order to make a smooth diffusion of the fuel and the CO₂ gas. This high porosity GDL causes non-uniform fuel delivery to the anode electrode along the anode channel. However, in order to enable ultra low fuel stoichiometry, uniform fuel distribution and delivery is desirable.

In view of the foregoing, there exists a need for improved DOFC/DMFC systems including an anode diffusion medium, more commonly known gas diffusion layer (GDL), which facilitates a reduction of methanol crossover.

### SUMMARY OF THE DISCLOSURE

To improve over the art and address one or more of the needs outlined above, a DOFC is configured to comprise a cathode and an anode, such that the anode includes a phase separation layer (PSL) positioned between a fuel channel plate and a GDL. Advantageously, the PSL is configured to include at least one porous layer, which improves fuel delivery and fuel cell performance.

In an embodiment, the instant application describes a DOFC comprising a cathode electrode; an electrolyte; and an anode electrode comprising a fuel channel plate, a gas diffusion layer (GDL), and a PSL positioned between the fuel channel plate and the GDL, such that the PSL comprises at least one porous layer.

Embodiments may include one or more of the following features. For example, the PSL may be configured to include a first side that faces the fuel channel plate and a second side that faces the GDL. In addition the second side of the PSL may be corrugated with a continuous flow field. Furthermore, the second side of the PSL may include an open end that may be configured to expel CO₂ and residual liquid or gas generated in the DOFC and a closed end that is positioned next to the first side of the PSL, the first side of the PSL not being corrugated with a continuous flow field. This arrangement prevents any CO₂ and residual liquid or gas generated in the DOFC to exit via the closed end. Another feature of the DOFC may be that the PSL is configured to allow liquid fuel to enter the PSL but to block gaseous CO₂ from entering the PSL. In addition, the PSL may be hydrophilic. The PSL may be made hydrophilic using a variety of methods. For example, the PSL may be coated with a hydrophilic agent, treated with an acid, such as sulfuric acid for a period of time equal to or greater than about five hours. In addition, or subject to plasma deposition with a hydrophilic substance.

Another feature of the present disclosure may be that the hydrophilic agent comprises a polar or charged functional group and is insoluble in water and methanol. Further, the hydrophilic agent may be selected from the group consisting of polysulfones, polyether sulfones, polyether ether ketones, polyether ketones, polyimides, poly (4-phenoxybenzoyl-1,4-phenylene), polyethers, polybenzimidazoles, polybenzothiazoles, polybenzoxazoles, silica dioxide and titanium dioxide. Also, the porosity of the PSL may be lower than that of the GDL and may be about 20%-77%, preferably between 40%-75% and more preferably between 60%-70%. In addition the GDL may comprise two layers sandwiching a catalyst coated membrane.

In another general aspect, the instant application describes a method, which involves making a DOFC comprising configuring an anode electrode comprising a fuel channel plate, a GDL, and a PSL positioned between the fuel channel plate and the GDL, such that the PSL comprises at least one porous layer.

Embodiments may include one or more of the following features. For example, the method may further comprise configuring the PSL to allow liquid fuel to enter the PSL but gaseous CO₂ to be blocked from entering the PSL. Additionally, the method may include coating at least one side of the PSL with a hydrophilic polymer selected from the group consisting of polysulfones, polyether sulfones, polyether ether ketones, polyether ketones, polyimides, poly(4-phenoxybenzoyl-1,4-phenylene), polyethers, polybenzimidazoles, polybenzothiazoles, polybenzoxazoles, silica dioxide and titanium dioxide.

Another feature of the present disclosure may be that the PSL includes a first side that faces the fuel channel plate and a second side corrugated with a continuous flow field that faces the GDL. Furthermore, the method may comprise configuring a second side of the PSL to include an open end configured to expel CO₂ and residual liquid or gas generated in the DOFC. Furthermore, the method may include configuring the porosity of the PSL to be about 20%-77%, preferably between 40-77% and more preferably between 60-70%. In addition, the method may involve configuring the GDL to include two layers which sandwich a catalyst coated membrane. An additional feature of the DOFC fuel is to use methanol as a fuel.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates schematic of an exemplary direct methanol fuel cell system operating directly on high concentration fuel in accordance with an embodiment of the present invention.

FIG. 2 is a schematic illustration of an anode structure with a phase separation layer (PSL).

FIG. 3 illustrates the steady state performance of DOFC having a PSL with 4 M methanol with different fuel stoichiometries at 40° C.

FIG. 4 illustrates CO₂ concentration for a DOFC having a PSL and a conventional DOFC.

FIG. 5 illustrates the fuel efficiency for a DOFC having a PSL and a conventional DOFC.

### DETAILED DESCRIPTION

In the following detailed description, numerous specific details are set forth by way of examples in order to provide an understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present disclosure.

The various technologies disclosed herein relate to DOFC having an anode electrode configured to comprise a phase separation layer (PSL) positioned between the fuel channel plate and the GDL, wherein the PSL comprises at least one porous layer.

To improve over the art and provide a DOFC that makes uniform fuel delivery while keeping anode GDL at a high porosity about 50-80%, thereby enabling smooth exhaust of CO₂ and also allowing free selection of channel designs in the fuel channel and CO₂ flow field fitted to all cell configurations, a DOFC anode cathode is configured to comprise a PSL positioned between the fuel channel plate and the GDL, wherein the PSL comprises at least one porous layer.

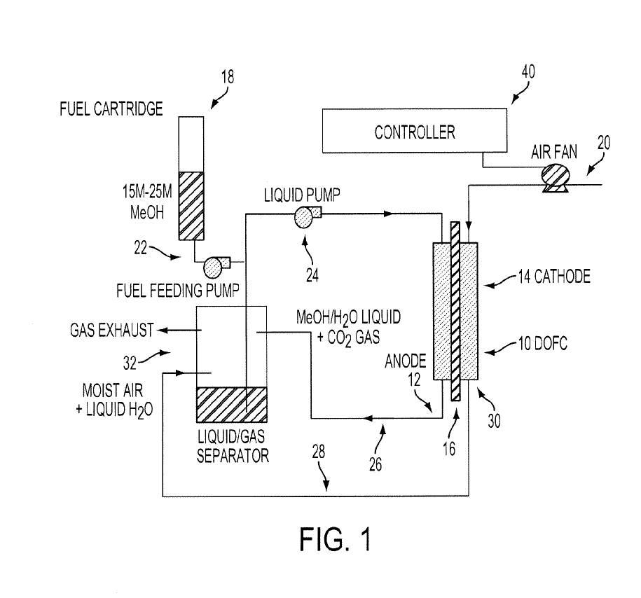

As a result, in one general aspect, the instant application describes a DOFC 10, such as a direct methanol fuel cell (DMFC) as shown in FIG. 1.

As shown in FIG. 1, the fuel cell system includes an anode 12, cathode 14, and a proton-conducting electrolyte membrane 16 such as NAFION, and GORE membranes, and hydrocarbon membranes like polyfuel, sulfonated polysulfone, sulfonated polyimide. Anode 12, cathode 14 and membrane 16 are preferably a multi-layered composite structure referred to as an MEA. Typically a fuel cell system will have a plurality of such MEAs in the form of a stack and such a cell stack is contemplated by the present disclosure. FIG. 1 only shows a single MEA for simplicity. Typically, the membrane electrode assemblies are separated by bipolar plates that have serpentine channels for supplying and returning fuel and by-products to and from the assemblies (not shown for illustrative convenience). In a fuel cell stack, MEAs and bipolar plates may be aligned in alternating layers to form a stack of cells and the ends of the stack are sandwiched with current collector plates and electrical insulating plated and the entire unit is secured with fastening structures.

The cathode electrode may include a gas diffusion medium (GDM) including a backing layer and a microporous layer (MPL). The materials for the backing layer may selected from carbon paper, nickel foam, metal wire or other porous material, and the materials for the MPL may be carbon powder and PTFE. The thickness range of backing layer maybe about 100 um-500 um, and the thickness range of MPL may be about 10 um-100 um).

A source of fuel, e.g. fuel container or cartridge 18, is in fluid communication with anode 12 and an oxidant, e.g. air controlled by fan 20, is in fluid communication with cathode 14. In accordance with aspects of the present disclosure, fuel supplied to the anode is in highly concentrated form, e.g., greater than about 1 M and preferably greater than about 3 M, 15 M, 20 M, etc. up to and including a substantially pure, i.e. neat, form of the fuel. In this particular example, methanol is contained in fuel cartridge 18 in a concentration between about 4 M. High concentrated fuel from fuel cartridge 18 can be fed directly into the liquid/gas separator 28 by pump 22, or directly into the anode by pump 22 and 24. In operation, the fuel is introduced to the anode side of the MEA or in the case of a cell stack to an inlet manifold of an anode separator of a cell stack. Excess fuel, water and CO₂ gas is withdrawn from the anode side of the MEA or anode cell stack through port 26 and into liquid/gas separator 28. The air or oxygen is introduced to cathode 14 and regulated to maximize electrochemically produced water in liquid form while minimizing water vapor and thus minimizing the escape of water vapor from the system.

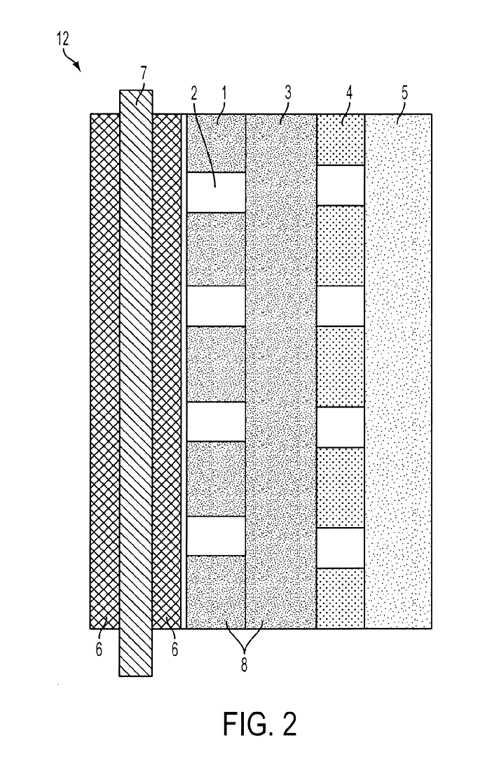

As shown in FIG. 2, the anode electrode 12 may comprise a fuel channel plate 4, gas diffusion layers (GDL) 6, and a phase separation layer (PSL) 8 that includes a sublayer 1 having a flow field 2 and a sublayer 3 that may have a NAFION/carbon surface layer and/or a hydrophilic surface. The fuel channel plate 4, may have a closed end so that all fuel flow through the PSL and makes more uniform fuel distribution.

The PSL 8 may be positioned between the fuel channel plate 4 and the GDLs 6. The PSL 8 may further comprise at least one porous layer. The thickness of PSL may be about 150-400 μm, preferably about 200-350 μm. The thickness of the flow field 2 may be about 80-250 μm, preferably about 100 to 225 μm. The fuel channel signal path may be a serpentine channel, and the width of the channel may be about 1.0 to 3.0 mm, preferably 1.5 to 2.5 mm.

PSL 8 may be configured to include a first side that faces the fuel channel plate 4 and a second side that faces the GDL 6. In addition the second side of the PSL may be corrugated with a continuous flow field. As used in this disclosure, the term “corrugated” is defined as having an alternating parallel grooves and ridges structure so that the PSL 8 and the flow field 2 can be two separated parts and one whole part. In other words, the PSL has alternating open flow fields portions and closed portions.

Furthermore, the second side of the PSL may include an open end that may be configured to expel CO₂ and residual liquid or gas generated in the DOFC/DMFC. Another feature of the DOFC/DMFC may be that the PSL is configured to allow liquid fuel to enter the PSL but to block gaseous CO₂ from entering the PSL. In addition, the PSL may be hydrophilic. The PSL may be made hydrophilic by coating one or more surface of the PSL with a hydrophilic agent.

This hydrophilic agent may include a polar or charged functional group and that is insoluble in water and methanol. Further, the hydrophilic agent may be selected from the group consisting of polysulfones, polyether sulfones, polyether ether ketones, polyether ketones, polyimides, poly (4-phenoxybenzoyl-1,4-phenylene), polyethers, polybenzimidazoles, polybenzothiazoles, polybenzoxazoles, silica dioxide and titanium dioxide. Also, the porosity of the PSL may be lower than the porosity conventional GDLs and may preferably be about 20%-77%, preferably between 40-77% and more preferably between 60-70%. In addition the GDL 6 may comprise two layers sandwiching a catalyst coated membrane 7. Examples of such a catalyst may be Pt/C, PtRu/C, PtIr/C, PtFe/C, Pt black, PtRu black, and PtFe black.

In another general aspect, the instant application describes a method, which involves making a direct oxidation fuel cell (DOFC) comprising configuring an anode electrode 12 comprising a fuel channel plate 4, GDL 6, and a phase separation layer (PSL) 8 positioned between the fuel channel plate 4 and the GDL 6, wherein the PSL 8 comprises at least one porous layer.

Embodiments may include one or more of the following features. For example, the method may further comprise configuring the PSL 8 to allow liquid fuel to enter the PSL 8 but gaseous CO₂ to be blocked from entering the PSL 8. Additionally, the method may include coating at least one side of the PSL with a hydrophilic polymer selected from the group consisting of polysulfones, polyether sulfones, polyether ether ketones, polyether ketones, polyimides, poly(4-phenoxybenzoyl-1,4-phenylene), polyethers, polybenzimidazoles, polybenzothiazoles, polybenzoxazoles, silica dioxide and titanium dioxide.

Another feature of the above general concept may be that the PSL 8 includes a first side that faces the fuel channel plate and a second side corrugated with a continuous flow field that faces the GDL 6. Furthermore, the method may comprise configuring a second side of the PSL 8 to include an open end configured to expel CO₂ and residual liquid or gas generated in the DOFC 10. Furthermore, the method may include configuring the porosity of the PSL to in the range of about 20%-77%, preferably between 40-75% and more preferably between 60-70%. In addition, the method may involve configuring the GDL to include two layers which sandwich a catalyst coated membrane.

### Examples

Example 1 PSL Cell. An anode electrode was prepared having a PSL. The PSL sublayer was made of plain porous carbon paper (TGPH-060) by creating a flow field. The fuel channel may be a signal path serpentine channel. The width of the channel is between 1.5 to 2.5 mm, preferably 1.85 to 2.3 mm.

The depth of the channel is between 225 and 175 μm, preferably between 200 and 185 μm, and another PSL sublayer not having a flow field was made of plain porous carbon paper (TGPH-030) having an approximate porosity of 80% coated on its surface with a NAFION/carbon thin layer. The thickness of the coating may be about 10 μm-100 μm. This PSL was then integrated into a DMFC cell with a hydrocarbon membrane of electrode area 12 cm². The DMFC cell included a NAFION 212 (available from Dupont) membrane and an electrode area of 12 cm² 10 wt % wet-proofed TGPH-90 Toray carbon paper was used as a GDL. To make a NAFION/carbon surface layer for PSL, a paste was made of mixing carbon powder (e.g. Vulcan XC-72R), 5 wt % NAFION solution, iso-propanol, and de-ionized water. The paste was then cast onto the surface of sublayer 3 of PSL to form a thin surface layer (˜15 μm), following by drying at 100° C. for 1 hour.

Comparative Example 1 Non-PSL Cell. A DOFC cell was prepared in the same manner as in Example 1, except, the anode electrode did not have a PSL structure.

DOFC Performance

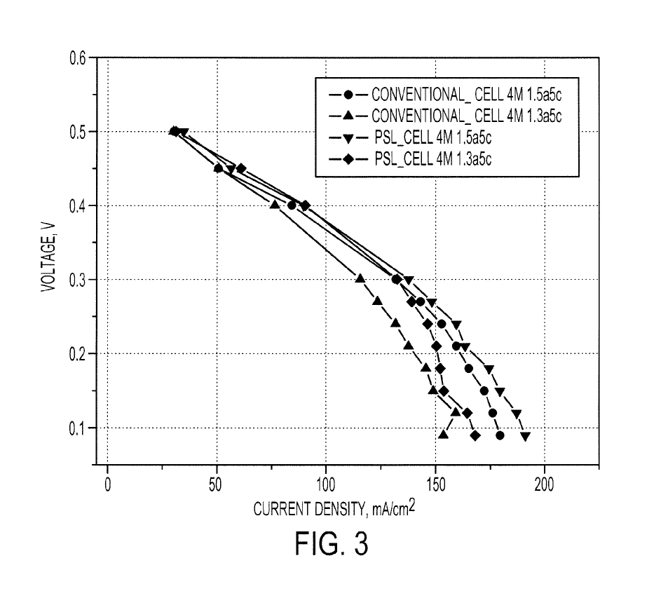

The DOFC cells of Example 1 and Comparative Example 1 were tested to evaluate cell performance. As shown in FIG. 3, the DOFC of Example 1 and Comparative Example 1 were tested using 4 M methanol, with different fuel stoichiometries (1.3 and 1.5) at 40° C. and voltage was measured as a function of current density, mA/cm². As used herein, the term the stoichiometries refers to the amount or ratio actually fed compared with the theoretical amount. The performance of the cells was tested under steady-state by measuring current at certain cell voltages, of 0.5 V, 0.45 V, 0.4 V, 0.3 V, 0.27 V, 0.24 V, 0.21 V, 0.18 V, 0.15 V, 0.12 V and 0.09 V. The cells were operated at each voltage point for 10 minutes. As shown in FIG. 3, the DOFC with a PSL (Example 1) showed ˜30-40 mV performance improvement as compared with that with the DOFC without PSL (Comparative Example 1) under low anode stoichiometry of 1.3 and fed by 4 M methanol. The performance increase was due to the better fuel distribution and less methanol crossover. FIG. 3 shows the CO₂ emission from the cathode that results. The results as shown in FIG. 3 indicate that DOFC cells of Example 1, having the PSL achieved unexpectedly improved voltage retention compared to the DOFCs of Comparative Example 1. Moreover, Applicants found that the greater the electrode area, the more significant the improvements achieved in fuel delivery and fuel cell performance with the use the above described PSL.

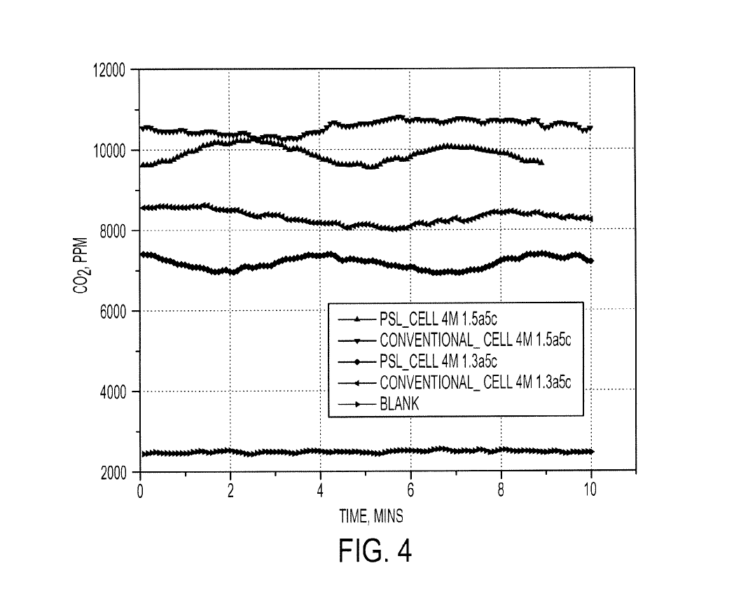

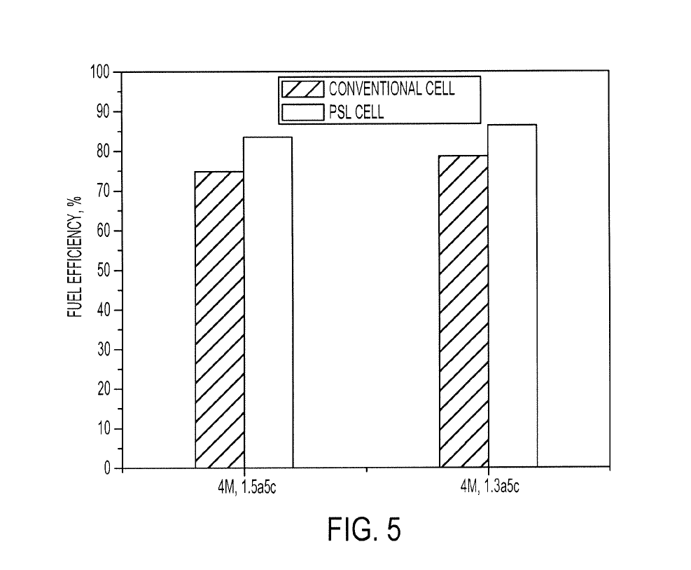

As shown in FIG. 4, the CO₂ emissions from the cathode that results from methanol crossover and its oxidation into CO₂ in the cathode catalyst layer were measured in the DOFCs of both Example 1 and Comparative Example 1. The CO₂ amount served as a direct measure of the level of methanol crossing over the membrane. The fuel efficiency was calculated from the measure of methanol crossover and plotted in FIG. 5 as a bar graph. A comparison of the DOFC of Example 1, having a PSL structure and Comparative Example 1, not having a PSL structure, indicated that lower methanol crossover occurred in the DOFC of Example 1, which in turn leads to higher fuel efficiency (about 3% higher as shown in FIG. 4) and alleviates the effect of mixed potential in the cathode.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A direct oxidation fuel cell (DOFC) comprising:
a cathode electrode;
an electrolyte; and
an anode electrode comprising a fuel channel plate, gas diffusion layer (GDL), and a phase separation layer (PSL) positioned between the fuel channel plate and the GDL, wherein the PSL comprises at least one porous layer.

2. The DOFC of claim 1, wherein the PSL comprises a first side that faces the fuel channel plate and a second side that faces the GDL and is corrugated with a continuous flow field.

3. The DOFC of claim 2, wherein the second side of the PSL comprises an open end configured to expel CO₂ and residual liquid or gas generated in the DOFC.

4. The DOFC of claim 1, wherein the PSL is configured to allow liquid fuel to enter the PSL but gaseous CO₂ is blocked from entering the PSL.

5. The DOFC of claim 4, wherein the PSL is hydrophilic.

6. The DOFC of claim 1, wherein at least one side of the PSL is coated with a hydrophilic agent.

7. The DOFC of claim 6, wherein the hydrophilic agent comprises a polar or charged functional group and is insoluble in water and methanol.

8. The DOFC of claim 6, wherein the hydrophilic agent is selected from the group consisting of polysulfones, polyether sulfones, polyether ether ketones, polyether ketones, polyimides, poly(4-phenoxybenzoyl-1,4-phenylene), polyethers, polybenzimidazoles, polybenzothiazoles, polybenzoxazoles, silica dioxide and titanium dioxide.

9. The DOFC of claim 1, wherein the porosity of the PSL is between 20% and 77%.

10. The DOFC, wherein the GDL comprises two layers sandwiching a catalyst coated membrane.

11. A method of making a direct oxidation fuel cell (DOFC) comprising:
configuring an anode electrode comprising a fuel channel plate, a gas diffusion layer (GDL), and a phase separation layer (PSL) positioned between the fuel channel plate and the GDL, wherein the PSL comprises at least one porous layer.

12. The method of claim 11, further comprising configuring the PSL to allow liquid fuel to enter the PSL but gaseous CO₂ to be blocked from entering the PSL.

13. The method of claim 12, further comprising coating at least one side of the PSL with a hydrophilic polymer selected from the group consisting of polysulfones, polyether sulfones, polyether ether ketones, polyether ketones, polyimides, poly(4-phenoxybenzoyl-1,4-phenylene), polyethers, polybenzimidazoles, polybenzothiazoles, polybenzoxazoles, silica dioxide and titanium dioxide.

14. The method of claim 11, wherein the PSL comprises a first side that faces the fuel channel plate and a second side corrugated with a continuous flow field that faces the GDL.

15. The method of claim 11, further comprising coating at least one side of the PSL with a hydrophilic polymer selected from the group consisting of polysulfones, polyether sulfones, polyether ether ketones, polyether ketones, polyimides, poly(4-phenoxybenzoyl-1,4-phenylene), polyethers, polybenzimidazoles, polybenzothiazoles, polybenzoxazoles, silica dioxide and titanium dioxide.

16. The method of claim 11, wherein the second side of the PSL comprises an open end configured to expel CO₂ and residual liquid or gas generated in the DOFC.

17. The method of claim 11, further comprising configuring the porosity of the PSL is between 20% and 77%.

18. The method of claim 17, wherein the porosity of the PSL is between 20-70%.

19. The method of claim 12, wherein the GDL comprises two layers sandwiching a catalyst coated membrane.

20. The method of claim 12, wherein said DOFC fuel is methanol.
